(19) United States
(12) Patent Application Publication
(10) Pub. No.: US 2007/0278465 A1
(43) Pub. Date: Dec. 6, 2007

(54) HOISTING DEVICE WITH A CATCH NUT

(75) Inventor: Eric LETELLIER, Charleville (FR)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SEFAC SOCIETE ANONYME, Montherme (FR)

(21) Appl. No.: 11/755,416

(22) Filed: May 30, 2007

(30) Foreign Application Priority Data
May 30, 2006 (FR) 0651950

(51) Int. Cl. B66F 3/08

(52) U.S. Cl. 254/98

(57) ABSTRACT

The invention relates to a hoisting device (1), in particular for a vehicle, including a substantially vertical column forming a frame and lifting means movable along said column under the action of the control, by adequate driving means, to cause a threaded rod (2) to rotate and a nut (3) integral with a carriage (4) bearing the load (20) to be lifted to move along the latter.

It is characterized in that this nut (3) is a catch nut, which comprises a first bearing nut (5) on which said carriage (4) rests, and a second safety nut (6) coaxial to the preceding one and placed below same, designed capable of receiving and bearing the load formed by said carriage (4) and its load (20) and by said first bearing nut (5) in the event of failure of the latter.

### BACKGROUND OF THE INVENTION

(1) Field of the Invention

The present invention relates to a hoisting device, in particular for a vehicle, including a substantially vertical column forming a frame and lifting means movable alongside said column under the action of the control, by adequate driving means, to cause a threaded rod to rotate and a nut integral with a carriage on which rests the load to be lifted to move along the latter.

The present invention will find its application in the field of the handling devices and, in particular, of the hoisting devices in particular for vehicles.

(2) Description of the Prior Art

The safety of the lifting stands, in particular for motor or railway vehicles, is an important problem, for which different solutions have been provided.

Many hoisting devices are in the form of a vertical column forming a frame, or of a plurality of such columns, resting on the floor through a base plate. Along such a vertical column are capable of moving lifting means in the form of one or several horizontal arms, or of a movable carriage. The latter is guided in displacement along the column through guiding means the latter is provided with, and complementary guiding means, which this carriage is provided with.

The control to cause the carriage to move is achieved, in particular, through a vertical threaded rod, rotationally mounted in the column, or forming the latter, and likely to be driven by driving means, namely of the electric type, the head of the column is provided with. Furthermore, a nut, made integral with the lifting means, is fitted on the threaded rod, so that, during the control to cause the latter to rotate, this nut moves upwards or downwards, thereby driving said lifting means.

It is obvious that these hoisting devices, intended to lift relatively important loads, comprise a number of safety devices preventing the load from moving downward in the event of any failure, in particular of the driving means.

There is known the use of so-called irreversible nuts, the helix angle of which is such that it opposes, in the direction of lowering of the load, a higher resistive torque than the torque produced by the downward movement of this load. The use of such low-efficiency nuts, subjected to high frictions and significant wear, requires a lubrication installation, as well as high driving power, which results into a high cost.

Other systems use high-efficiency reversible nuts, of the ball-nut type, or made of polyamide or also of a composite material. Such systems incorporate electrically or electronically controlled safety systems the function of which is to instantaneously detect an involuntary downward movement of the lifting means, and to immediately immobilize the latter. However, such systems require being themselves double, because the safety system is sensitive to the slightest failure of a circuit or a connection.

FR 2 701 252 contemplates using, in combination with a reversible nut, friction means capable of creating, during the downward movement of the lifting means, a resistive torque higher than the torque produced by the load during its downward movement, the system also comprising means capable of canceling the effect of the friction means during the control to cause the lifting means to move upwards. This reliable solution requires however a power consumption during the control to cause the load to move upwards.

All things considered, these known solutions for ensuring the safety, vis-à-vis the risk of an unexpected downward movement of the load, are either handling and/or greasing-power-consuming, or result from the combination with electric or electronic systems that must be double, in order to ensure a sufficient safety.

From GB 2 065 600 is also known a hoisting device for a vehicle, with, on a lifting column, a housing comprising a first bearing nut cooperating with a screw, and a second safety nut, coaxial to the preceding one and below same; this device does not comprise means for making the first and the second nut integral with each other when they are separated from each other. No means allows preventing the bearing nut from breaking.

Similarly, DE 29 21 835 discloses a hoisting device with two columns each comprising a carriage with a bearing nut and a safety nut, both carriages being connected, through a set of pulleys, by a cable to which are attached end stops for controlling the action of motors independent from the driving of the endless screws of the two columns. Each end of the cable is connected to a support designed to be deformed by folding in the event of a fall of a bearing nut, in order to trigger the stoppage of the motor involved in the event of breaking of the bearing nut.

DE 202 07 273 also discloses a system with a bearing nut and a safety nut, connected by a pin that maintains a constant distance between them, which results, in the event of breaking of the bearing nut, into a falling down of the load onto the safety nut.

The known solutions of the state of the art provide safety in the event of breaking, but they are not designed to cope with and visualize the wear of the bearing nut. Though they allow an immobilization of the hoisting device in the event of breaking of nut, they are ill-adapted for depositing the lifted load on the floor.

### SUMMARY OF THE INVENTION

The aim of the invention is to cope with the drawbacks of the state of the art by providing an economic, fully mechanical solution, which also allows preventing the possible failure due to wear of the most exposed component. This solution also allows equipping existing installations and making them safe, at low cost and without requiring a long immobilization.

To this end, the invention relates to a hoisting device, in particular for a vehicle, including a substantially vertical column forming a frame and lifting means movable along said column under the action of the control, by adequate driving means, to cause a threaded rod to rotate and a nut integral with a carriage on which rests the load to be lifted to move along the latter, said nut being a catch nut, which comprises a first bearing nut on which said carriage rests, and a second safety nut coaxial to the preceding one and placed below same, and designed capable of receiving and bearing the load formed by said carriage and the load the latter bears and said first bearing nut in the event of failure of the latter, in particular due to wear or breaking, characterized in that said catch nut comprises guiding means, which are designed capable of cooperating with complementary guiding means, so as to make said first bearing nut and said second safety nut integral in rotation when they are separated from each other, and to cease cooperating with said complementary guiding means when said first bearing nut and said second safety nut are into contact with each other.

According to another feature of the invention, said first bearing nut is, when new, separated from said second safety nut.

According to an additional feature of the invention, said catch nut comprises at least a wear indicator for said first bearing nut.

According to a particular feature, said wear indicator compares the position of a fixed surface of said second safety nut to that of a reference mark integral with said first bearing nut.

Other features and advantages of the invention will clearly appear from the following detailed description of the non-restrictive embodiments of the invention, with reference to the attached drawings.

### BRIEF DESCRIPTION OF THE DRAWINGS

FIG. 1 represents, schematically and partially, an elevational view of part of a hoisting device according to the invention, in its normal working range;

FIG. 2 is a view similar to FIG. 1, representing the same device, in a degraded operating mode.

### DETAILED DESCRIPTION OF THE PREFERRED EMBODIMENTS

The invention relates to a hoisting device 1, namely designed for lifting vehicles.

Such a device 1 includes a substantially vertical column forming a frame.

It also includes lifting means, which are movable alongside this column under the action of the control, by adequate driving means, to cause a threaded rod 2 to be rotated a and a nut 3 to be moved along the latter.

On this nut 3 rests, or is mounted integral with, a carriage 4 on which rests a load 20 to be lifted, not shown in the figures.

It will be understood that a hoisting device comprised of the juxtaposition of several devices as described, namely with, in a traditional way, an even number of columns, falls within the spirit of the invention, and that the present description is limited to only one column only for reasons of simplification.

The nut 3 is a catch nut. It is comprised of several elements, which are designed capable of cooperating with each other, in certain fields of application according to the level of wear of its components.

The nut 3 comprises a first bearing nut 5, on which the carriage 4 rests directly.

It also comprises a second safety nut 6, which is coaxial to the first bearing nut 5, and which is placed below same.

Though the first bearing nut 5 is designed capable of supporting the weight of the carriage 4 and the load 20 this carriage bears, the second safety nut 6 is designed capable of receiving and bearing both the weight the carriage 4 and the load 20 represent and that represented by the first bearing nut 5 itself.

Thus, in the event of failure of the first bearing nut 5, in particular due to wear or breaking, in particular at the level of its internal thread, the second safety nut 6 is so dimensioned and installed as to bear, not only the static load represented by the sum of the weight of the carriage 4 and the load 20 this carriage bears, and of that of the first nut 5, but also, the dynamic load related to the eventual fall of the first bearing nut 5 and the unit it bears, comprised of the carriage 4 and the load 20.

This operation after failure of the first bearing nut 5 will be called, in the following description, degraded mode, That is why, though the first bearing nut 5 is preferably chosen of a material having a good friction coefficient, and allowing avoiding the placing of an expensive lubrication installation, such as for example made of bronze, the second safety nut 6 is preferably made of a ferrous alloy, and in particular of a steel grade chosen for its impact fatigue strength.

The second safety nut 6 is not intended, under normal service, to bear the weight of the carriage 4 and the load 20 this carriage 4 bears. Thus bearing only its own weight, the second safety nut 6 wears to a negligible extent, compared to the wear of the first bearing nut 5 that bears the weight of the carriage 4 and the load 20 this carriage 4 bears.

It will be understood that, under normal operation conditions, only the first bearing nut 5 bears the weight of the carriage 4 and the load 20 this carriage bears.

By contrast, in the degraded mode, only the second safety nut 6 bears the total load comprised of the weight of the carriage 4 and the load 20 this carriage bears, on the one hand, and the weight of the first nut 5, on the other hand.

It is not possible to install the first bearing nut 5 and the second safety nut 6 united to each other. Indeed, since they have to solve different problems, they have different friction coefficients, and the first bearing nut 5 wears more quickly than the second safety nut 6. A united mounting would inevitably result, after some time, into a wedge effect, and into wear of the second safety nut 6, which would as a matter of fact be contrary to the aim of safety the present invention pretends to ensure.

Therefore, when new, the first bearing nut 5 and the second safety nut 6 are, by construction, separated from each other.

In the normal operating mode, they remain separated from each other, but at a distance decreasing over time, according to the difference in wear between the two nuts.

To this end, the catch nut 3 according to the invention comprises guiding means 7, which are designed capable of cooperating with complementary guiding means 7A, in order to make the first bearing nut 5 and the second safety nut 6 integral in rotation when they are separated from each other.

It is only in degraded mode, beyond a certain level of wear of the first bearing nut 5, in particular after its breaking, that the first bearing nut 5 and the second safety nut 6 are into contact with each other.

The guiding means 7 are also designed capable of ceasing cooperating with the complementary guiding means 7A when the first bearing nut 5 and the second safety nut 6 are into contact with each other. The latter are then no longer integral in rotation.

And it will be understood that, in such case, the first bearing nut 5 is not capable of cooperating with the threaded rod 2.

Only the second safety nut 6 is driven by this threaded rod 2, and the only motion transmitted to the first bearing nut 5 results from the friction at the level of the joining surface, preferably a joining plane between the first bearing nut 5 and the second safety nut 6.

As can be seen in the figures, the guiding means 7 and the complementary guiding means 7A, in a preferred and in no way restrictive embodiment, consist of the combination of a catch 11 integral with the first 5 or the second 6 nut, and of a groove 12 parallel to the direction of the threaded rod 2 and open in its lower portion 13, this groove 12 being integral with the second 6 or the first 5 nut, respectively.

Though the figures show an embodiment, in which the catch 11 is integral with the first bearing nut 5, and the groove 12 is integral with the second safety nut 6, it is understood that the reverse combination is possible as well.

One will of course understand that such guiding means 7 and such complementary guiding means 7A can, without changing the spirit of the invention, be double and distributed over the periphery of the two nuts 5 and 6, for example in a diametrically opposite way.

The respective dimensioning of the guiding means 7 and the complementary guiding means 7A, in particular of the catch 11 and the groove 12, is so calculated that, in this non-restrictive exemplary embodiment, the catch 11 can be released from the groove 12 on the side of the opening in its lower portion 13 when the first bearing nut 5 enters into contact with the second safety nut 6, in order to make the second safety nut 6 independent in rotation from the first bearing nut 5.

Thus, the first bearing nut 5 enters into contact with the second safety nut 6 only when the internal thread of said first bearing nut 5 is broken, which coincides with the ceasing of cooperation of the guiding means 7 and the complementary guiding means 7A.

In order to prevent a fall of the first bearing nut 5 and the unit it bears, which necessarily results into impacts prejudicial to the whole mechanism, the catch nut 3 according to the invention comprises at least one wear indicator 8 for the first bearing nut 5.

In a particular embodiment, as can be seen in the figures, the wear indicator 8, not shown as such, compares the position of a fixed surface 9 of the second safety nut 6 to that of a reference mark 10 integral with the first bearing nut 5.

As can be seen in the figures, the fixed surface 9 of the second safety nut 6 advantageously consists of the upper surface, preferentially flat and perpendicular to the axis of the threaded rod 2, of the latter.

The reference mark 10 is advantageously calculated so as to be, when the nuts 5 and 6 are new, in front of the surface 9 of the second safety nut 6.

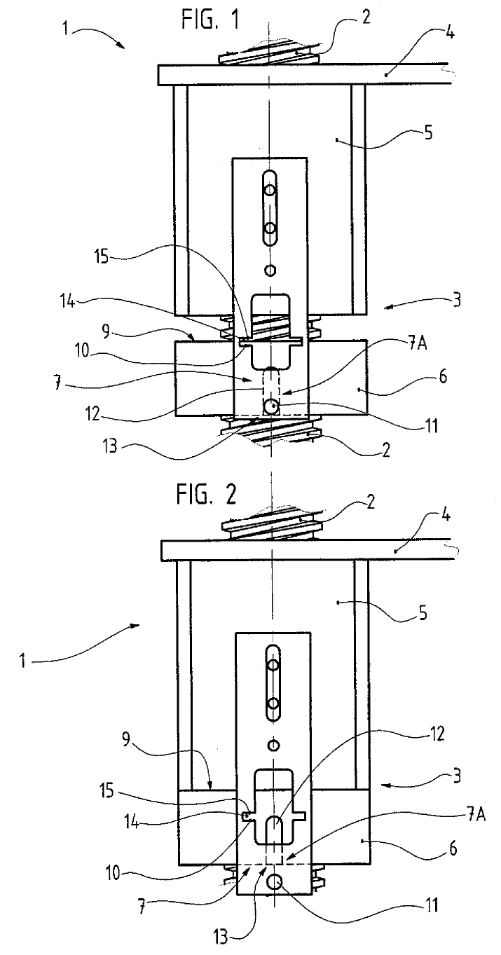

As the operation of the device 1 according to the invention progresses, the first nut 5, under the effect of its wear, will move closer to the second safety nut 6. As can be seen in FIG. 1, the surface 9 will separate upwardly from the reference mark 10.

The distance between this surface 9 and this reference mark 10 provides the maintenance service with direct information on the state of wear of the first bearing nut 5.

In a preferred embodiment, the wear indicator 8 comprises a reading window 14, which is provided with a maximum nominal wear mark 15.

As can be seen in the figures, in a preferred embodiment, the reading window 14, edged by the reference marks 10 and 14, is provided for on a plate integral with the first bearing nut 5, which plate also bears the catch 11.

This very simple design is of a particularly low cost, and allows a good visibility of the state of the installation by the user.

The surface 9 will move, under the user's eyes, in this reading window 14 between the reference marks 10 and 15, which show the area of normal use.

The coincidence of the surface 9 with this maximum nominal wear mark 15 signals to the maintenance service the need for an intervention at the level of the first bearing nut 5; when the reading window 14 is filled by second nut 6, the first bearing nut 5 must be changed.

When the hoisting device 1 operates in degraded mode, the friction coefficient between the upper face of the second safety nut 6, which comes into contact with the lower face of the first bearing nut 5, and the latter, is calculated so that the resistive torque is sufficient to authorize the lowering of the load 20, but that it is insufficient to authorize same to be lifted. All things considered, the user can lower his load 20, and release the carriage 4, and thus come out of a blocked situation, but he cannot re-use the hoisting device 1 without a complete repair of the catch nut 3 according to the invention.

It should also be noted that the hoisting device I according to the invention preferably incorporates lubrication or greasing means, at the level of the threaded rod 2 and/or the catch nut 3. Because of this lubrication, the threaded rod 2 is not damaged during the travel of the second safety nut 6, and they are both re-usable.

One understands very well that, according to the design of the invention, the safety of device 1 remains guaranteed, even when the users ignore the usual precautions. However, the cost of maintenance is different in the event of a mere exchange, or a repair after breaking. The bearing nut 5, which can be recovered, for example through association with other threaded rods, in the case of planned maintenance, can of course no longer be so in the event of breaking.

In this respect, it should be noted that, despite all the precautions taken during their manufacture, the bronze nuts can exhibit undetectable metallurgical defects when they are new, and break, under the effects of some vibrations or tiny efforts, which makes the device according to the invention particularly interesting.

Of course, the invention is not limited to the examples shown and described above, which can have variants and modifications without departing from the scope of the invention.

1. Hoisting device, in particular for a vehicle, including a substantially vertical column forming a frame and lifting means movable along said column under the action of the control, by adequate driving means, to cause a threaded rod to rotate and a nut integral with a carriage on which rests the load to be lifted to move along the latter, said nut being a catch nut, which comprises a first bearing nut on which said carriage rests, and a second safety nut coaxial to the preceding one and placed below same, and designed capable of receiving and bearing the load formed by said carriage and the load the latter bears and said first bearing nut in the event of failure of the latter, in particular due to wear or breaking, wherein said catch nut comprises guiding means, which are designed capable of cooperating with complementary guiding means, so as to make said first bearing nut and said second safety nut integral in rotation when they are separated from each other, and to cease cooperating with said complementary guiding means when said first bearing nut and said second safety nut are into contact with each other.

2. Hoisting device according to claim 1, wherein said guiding means and said complementary guiding means consist of the combination of a catch integral with the first or the second nut, and of a groove parallel to the direction of the threaded rod and open in its lower portion, this groove being integral with the second or the first nut, respectively.

3. Device according to claim 2, wherein said catch and said groove are calculated so as to allow the catch to be released from the groove on the side of the opening in its lower portion when said first bearing nut enters into contact with said second safety nut, in order to make the second safety nut independent in rotation from the first bearing nut.

4. Device according to claim 1, wherein said first bearing nut is, when new, separated from said second safety nut.

5. Device according to claim 1, wherein said catch nut comprises at least a wear indicator for said first bearing nut.

6. Device according to claim 5, wherein said wear indicator compares the position of a fixed surface of said second safety nut to that of a reference mark integral with said first bearing nut.

7. Device according to claim 5, wherein said wear indicator comprises a reading window provided with a maximum nominal wear mark.

8. Device according to claim 1, wherein said first bearing nut has a friction coefficient lower than that of said second safety nut.

9. Devices according to claim 1, wherein said first bearing nut is made out of bronze, and said second safety nut is made out of steel.

10. Device according to claim 2, wherein said first bearing nut is, when new, separated from said second safety nut.

11. Device according to claim 3, wherein said first bearing nut is, when new, separated from said second safety nut.

12. Device according to claim 2, wherein said catch nut comprises at least a wear indicator for said first bearing nut.

13. Device according to claim 3, wherein said catch nut comprises at least a wear indicator for said first bearing nut.

14. Device according to claim 4, wherein said catch nut comprises at least a wear indicator for said first bearing nut.

15. Device according to claim 10, wherein said catch nut comprises at least a wear indicator for said first bearing nut.

16. Device according to claim 11, wherein said catch nut comprises at least a wear indicator for said first bearing nut.

17. Device according to claim 12, wherein said wear indicator compares the position of a fixed surface of said second safety nut to that of a reference mark integral with said first bearing nut.

18. Device according to claim 13, wherein said wear indicator compares the position of a fixed surface of said second safety nut to that of a reference mark integral with said first bearing nut.

19. Device according to claim 14, wherein said wear indicator compares the position of a fixed surface of said second safety nut to that of a reference mark integral with said first bearing nut.
